(19) United States
(12) Patent Application Publication
(10) Pub. No.: US 2025/0256676 A1
(43) Pub. Date: Aug. 14, 2025

(54) MOLDED/BACK-INJECTED TRIM PANELS

(71) Applicant: Tesla, Inc., Austin, TX (US)

(72) Inventors: Shail Trivedi, Cupertino, CA (US); Harsh Modi, Pleasanton, CA (US); Avinash Danda, Fremont, CA (US); Shakeel Theodore, Fremont, CA (US); Stuart Scolaro, San Jose, CA (US); Rene Sanchez Nava, Lathrop, CA (US); Rahul Thakkar, Livermore, CA (US)

(73) Assignee: Tesla, Inc., Austin, TX (US)

(21) Appl. No.: 18/441,347

(22) Filed: Feb. 14, 2024

(51) Int. Cl. B60R 21/2165; B29C 45/14; B29K 21/00; B29K 23/00; B29L 31/30; B32B 3/30; B32B 25/08

(52) U.S. Cl. CPC B60R 21/2165; B29C 45/14; B32B 3/30; B32B 25/08; B29C 2045/1486; B29C 2793/0027; B29K 2021/003; B29K 2023/12; B29L 2031/3038; B32B 2605/003

(57) ABSTRACT

A resin material can be injection molded onto a thermoplastic material, thereby chemically bonding the resin material to the thermoplastic material and forming a structure comprising a first side comprising the thermoplastic material and a second side comprising the resin material.

### BACKGROUND OF THE DISCLOSURE

Thermoplastic polyolefin (TPO) and similar materials are frequently used to form surfaces that are likely to be exposed to sunlight, because they do not degrade under solar UV radiation. For example, automotive interior panels are often formed from and/or coated with TPO, which provides an attractive, yet durable, surface.

### SUMMARY OF THE DISCLOSURE

Embodiments described herein may provide a structure comprising a first side comprising a thermoplastic material and a second side chemically bonded to the first side by injection molding. The second side may comprise a resin material. In some embodiments, the thermoplastic material may comprise at least one thermoplastic elastomer (TPE). In some embodiments, the at least one TPE may comprise thermoplastic polyolefin (TPO). In some embodiments, the resin material may comprise at least one polyolefin. In some embodiments, the at least one polyolefin may comprise polypropylene. In some embodiments, the thermoplastic material may comprise a tear seam. In some embodiments, the tear seam may comprise a molded portion of the thermoplastic material that is thinner than a surrounding portion of the thermoplastic material. In some embodiments, the first side may comprise a textured outer surface. In some embodiments, the second side may comprise at least one surface feature configured to interface with at least one of a vehicle structure and a vehicle component. In some embodiments, the vehicle component may comprise an airbag housed by the at least one surface feature of the second side.

Embodiments described herein may provide a method comprising injection molding a resin material to a thermoplastic material, thereby chemically bonding the resin material to the thermoplastic material and forming a structure comprising a first side comprising the thermoplastic material and a second side comprising the resin material. In some embodiments, the thermoplastic material may comprise at least one TPE. In some embodiments, the at least one TPE may comprise TPO. In some embodiments, the resin material may comprise at least one polyolefin. In some embodiments, the at least one polyolefin may comprise polypropylene. In some embodiments, the method may further comprise forming a texture on an outer surface of the thermoplastic material. In some embodiments, the method may further comprise forming a tear seam in the thermoplastic material. In some embodiments, forming the tear seam may comprise molding a portion of the thermoplastic material to be thinner than a surrounding portion of the thermoplastic material. In some embodiments, the method may further comprise trimming at least one of excess thermoplastic material and excess resin material after the molding.

Embodiments described herein may provide method comprising loading a sheet of thermoplastic material into a frame; heating the thermoplastic material; placing the frame into an injection tool; injecting a resin material onto one side of the thermoplastic material, thereby chemically bonding the resin material to the thermoplastic material and forming a structure comprising a first side comprising the thermoplastic material and a second side comprising the resin material; and ejecting the structure from the injection tool.

### BRIEF DESCRIPTION OF THE FIGURES

Various objectives, features, and advantages of the disclosed subject matter can be more fully appreciated with reference to the following detailed description of the disclosed subject matter when considered in connection with the following drawings, in which like reference numerals identify like elements.

FIG. 1A shows a first side (A side) of a structure comprising a thermoplastic material according to some embodiments of the present disclosure.

FIG. 1B shows a second side (B side) of a structure comprising a resin material according to some embodiments of the present disclosure.

FIG. 1C shows a cross section of a structure with a thermoplastic material A-side and a resin material B-side according to some embodiments of the present disclosure.

FIG. 2A shows a B-side view of a panel with a thermoplastic material A-side and a resin material B-side according to some embodiments of the present disclosure. FIGS. 2B and 2C show alternate B-side views of a panel with a thermoplastic material A-side and a resin material B-side according to some embodiments of the present disclosure.

FIG. 2D shows an A-side view of a panel with a thermoplastic material A-side and a resin material B-side according to some embodiments of the present disclosure. FIG. 2E shows an alternate A-side view of a panel with a thermoplastic material A-side and a resin material B-side according to some embodiments of the present disclosure.

FIG. 3 shows a method of manufacturing a structure according to some embodiments of the present disclosure.

The drawings are not necessarily to scale, or inclusive of all elements of a system, emphasis instead generally being placed upon illustrating the concepts, structures, and techniques sought to be protected herein.

### DETAILED DESCRIPTION OF EMBODIMENTS

The following embodiments disclosed in the detailed description are merely examples and are not intended to limit the claimed invention or the applications of its use.

Embodiments disclosed herein provide molded and/or back injected trim panels and methods of producing the same. Even though TPO is commonly used in the automotive industry and many other industries, forming structural and/or surface panels and other large components out of TPO is often expensive and complicated. TPO is also not always suitable for all types of components where its properties would be otherwise desirable, such as panels with thin seams like airbag-concealing panels within automotive interiors. The disclosed embodiments provide techniques for reducing the cost and complexity of TPO structures while broadening their utility.

For example, embodiments disclosed herein may provide panels made of TPO on a first, outward-facing side (A side) with a plastic resin back injected onto the second, inward-facing side (B side) thereof. By choosing suitable materials and injection techniques, the two materials may be bonded chemically without adhesive, which can reduce complexity and improve durability. Moreover, this can allow the bonded materials to form complex geometric shapes (e.g., 90 degree angles, etc.) without risk of delamination. The disclosed techniques can be employed in a variety of injection molding equipment, making them accessible and economical.

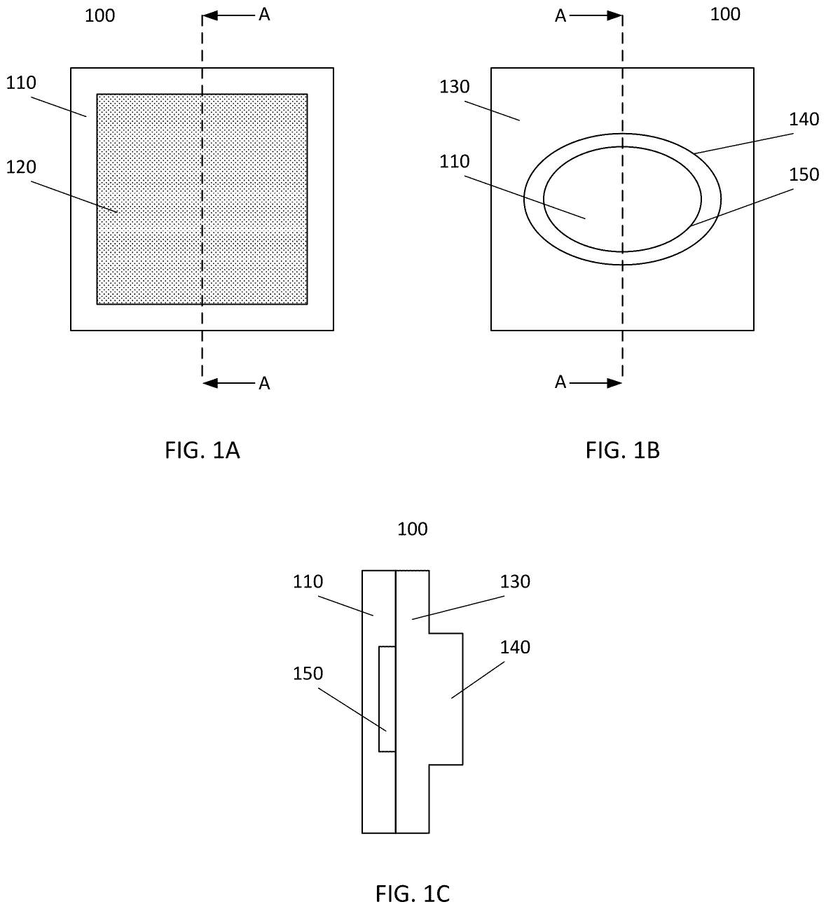

FIG. 1A shows a first side (A side), FIG. 1B shows a second side (B side), and FIG. 1C shows a cross section along line A, of a structure 100 with a thermoplastic material A-side and a resin material B-side according to some embodiments of the present disclosure. The A-side may comprise a thermoplastic material 110, while the B-side may comprise a resin material 130. As described in detail herein, the resin material 130 can be chemically bonded to the thermoplastic material 110 by injection molding without requiring chemical, mechanical, or other additional adhesives.

The A-side thermoplastic material 110 may comprise at least one TPE. In some embodiments, the at least one TPE may comprise TPO. TPO may be selected because it can be easily matched with other elements of the environment wherein structure 100 is installed, such as other trim components of a vehicle interior. However, embodiments may employ any member of the TPE material family as the A-side thermoplastic material 110, which may include, but is not limited to, TPE-S, TPE-V, and/or TPE-E. In some embodiments, the outer surface of A-side thermoplastic material 110 may include a textured outer surface 120. Texture can be molded into thermoplastic material 110 and/or formed in thermoplastic material 110 by tooling or other post-formation work. In various embodiments, portions of the outer surface of A-side thermoplastic material 110 may be textured, or the entire outer surface of A-side thermoplastic material 110 may be textured, or multiple different textures may be formed on different sections of the outer surface of A-side thermoplastic material 110.

The B-side resin material 130 may comprise at least one polyolefin. In some embodiments, the at least one polyolefin may comprise polypropylene. Other embodiments may use other polyolefins which may or may not include mineral fillers and/or other adjuncts. In some embodiments, the B-side resin material 130 may have a uniformly thick surface bonded to some or all of the rear of the A-side thermoplastic material 110. In some embodiments, the B-side resin material 130 may include at least one surface feature 140 that can vary in thickness. Some embodiments may have a combination of a uniformly thick surface portion and one or more surface features 140. In embodiments where at least one surface feature 140 is present, at least one surface feature 140 may be configured to interface with at least one of a vehicle structure and a vehicle component, such as an airbag housed by the at least one surface feature 140, for example.

In some embodiments, the B-side resin material 130 may be disposed and bonded along an entire back side of the A-side thermoplastic material 110. In other embodiments, at least a portion of thermoplastic material 110 may remain exposed on the B-side. In some embodiments, this exposed portion of thermoplastic material 110 may have at least one tear seam 150 formed therein. For example, tear seam 150 may comprise a molded portion of thermoplastic material 110 that is thinner than a surrounding portion of thermoplastic material 110. Tear seam 150 may be molded to be thinner than the surrounding portion and/or may be formed by scoring or otherwise partially removing thermoplastic material 110 to form a thin region. Tear seams 150 may be useful for structures 100 having components such as airbags housed therein. For example, an airbag may be held by and/or within surface feature 140 and, if activated, can punch through the weakened portion of thermoplastic material 110 formed by tear seam 150.

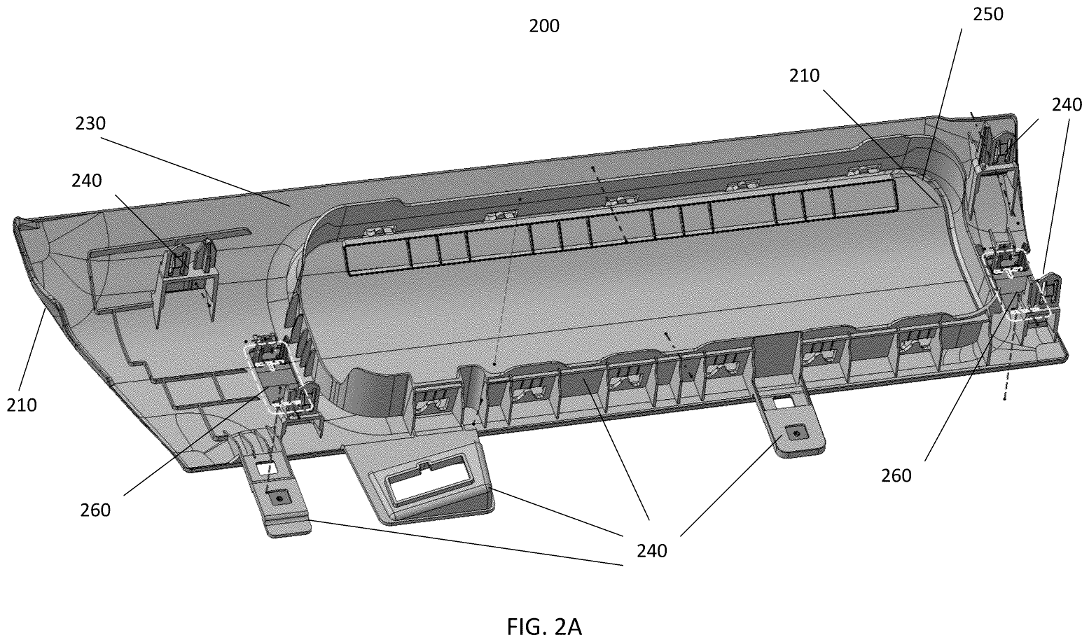

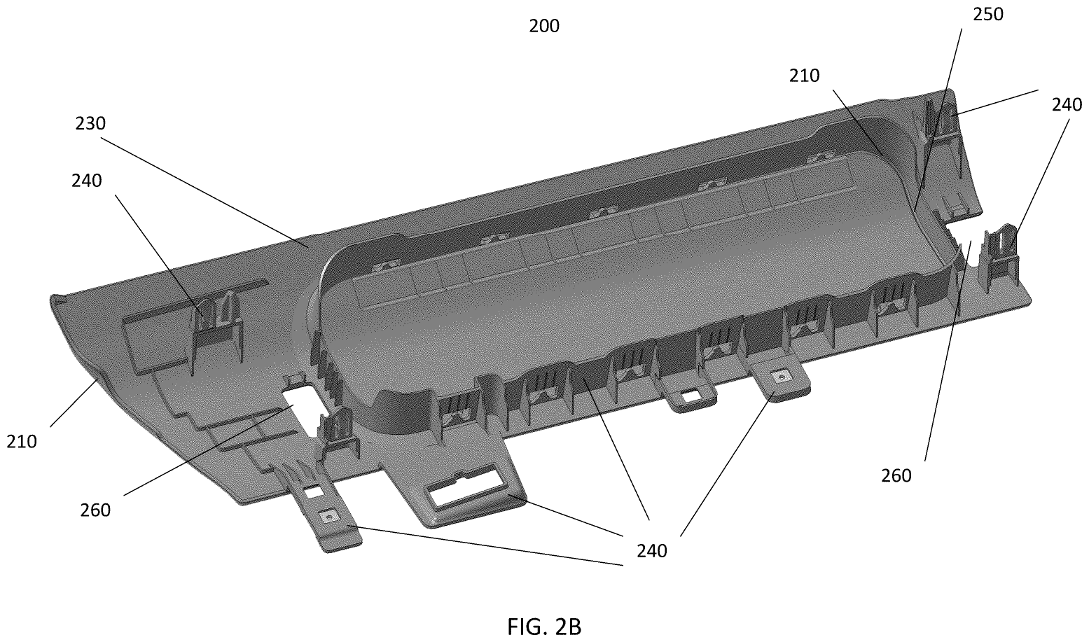

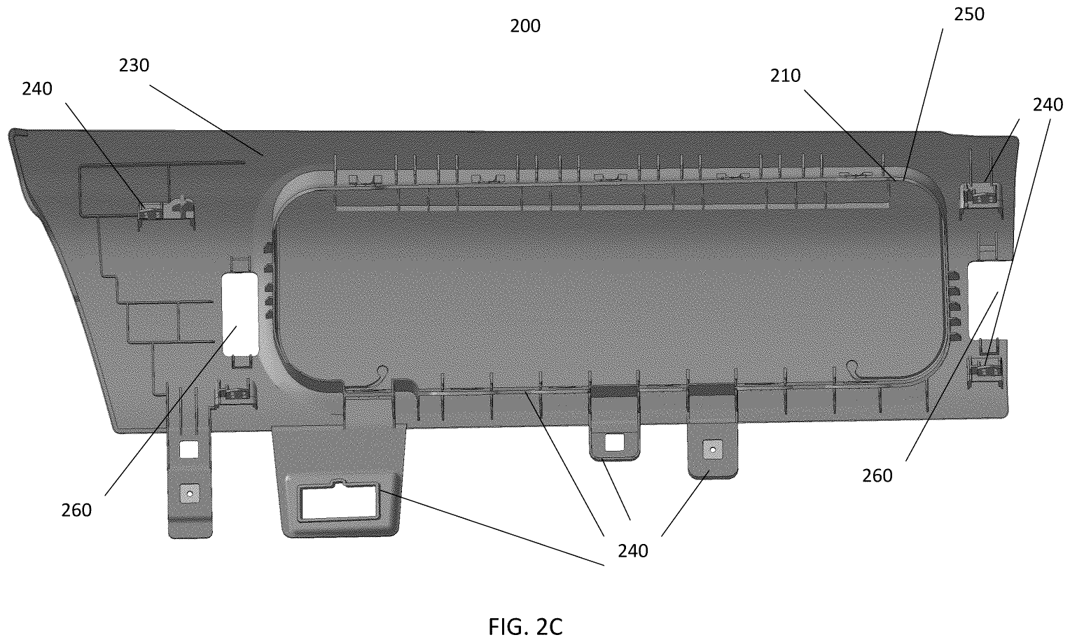

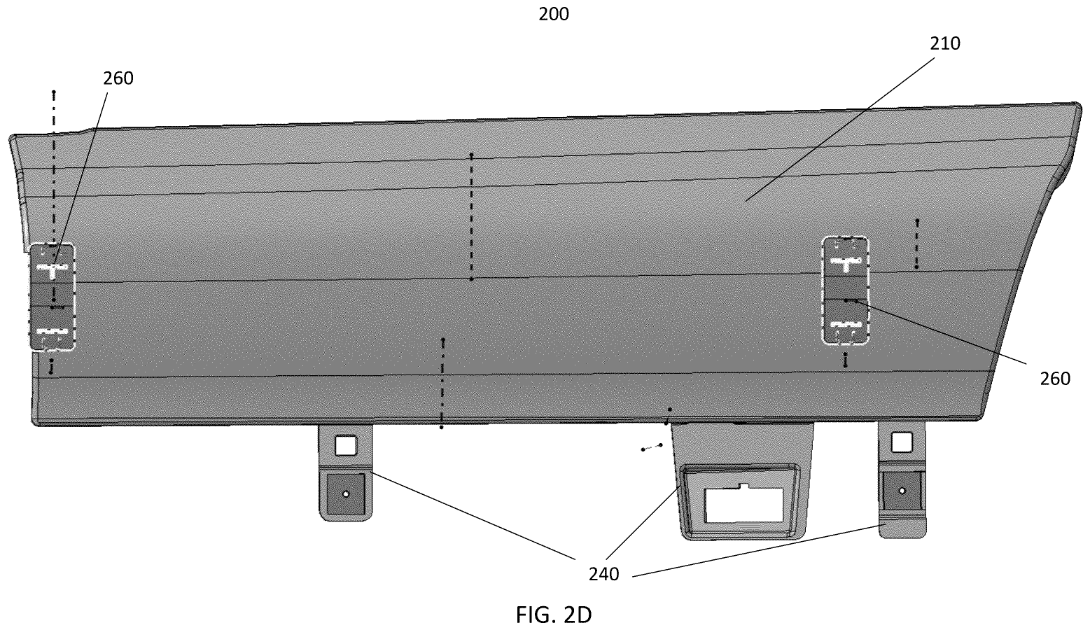

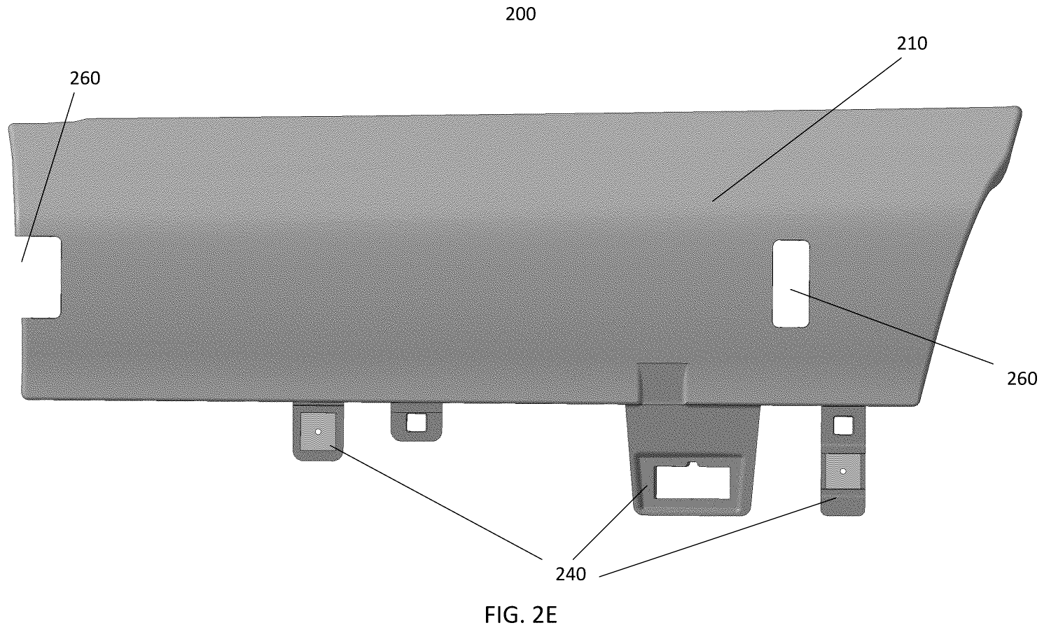

FIGS. 2A-2C show a series of alternate B-side views, and FIGS. 2D-2E show a series of alternate A-side views, of a panel 200 with a thermoplastic material A-side and a resin material B-side according to some embodiments of the present disclosure. Panel 200 is a representative example of a structure 100 that may be suitable for use as an automotive trim panel, although it will be understood that structure 100 can be used to create trim panel shapes and configurations that differ from the example of panel 200.

Example panel 200 is an example of an automobile interior trim panel configured to house and cover a knee airbag. Panel 200 is used as a representative component to illustrate possible features of various embodiments, but it will be understood that the disclosure is not limited to knee airbag enclosures. Consistent with the embodiments of FIG. 1A-1C, panel 200 may be used as knee airbag trim and may be created using a low pressure molding or back-injection process to provide a premium surface finish using artificial leather (e.g., polypropylene), but without the need for adhesive application, laser scoring, or post-process edge-wrapping. Panel 200 can have a functionally robust design for knee airbag deployments that is compliant with federal motor vehicle safety standards and regulations with a molded tear seam, with reduced material use and cost, reduced mass, and improved A-side surface appearance as compared with molded plastic panels and/or other alternative panels.

Similar to structure 100, panel 200 can include thermoplastic material 210 exposed on the A-side and resin material 230 exposed on the B-side. At least a portion of thermoplastic material 210 may also be exposed on the B-side and may have one or more tear seams 250 formed therein. One or more surface features 240 may be formed in resin material 230, such as clips, tabs, airbag support structures, etc. One or more cutouts 260 may also be formed in the shape of panel 200, either by molding thermoplastic material 210 and/or resin material 230 to have cutouts 260 therein, or by removing material to form cutouts 260 after assembling the main structure of panel 200.

In the examples of FIGS. 2A and 2B, a portion of A-side surface thermoplastic material 210 is visible at the left side of panel 200, even though the view is primarily of the B-side. This is because panel 200 is curved at the left side in this example, making the A-side surface visible along the left edge from the illustrated perspective. This demonstrates that panel 200 (or any structure 100 formed as described herein) may be curved. Because thermoplastic material 210 and resin material 230 are directly bonded together chemically, curves and other complex shapes can be achieved without risking delamination, unlike other techniques where adhesives are used to bond layers, for example.

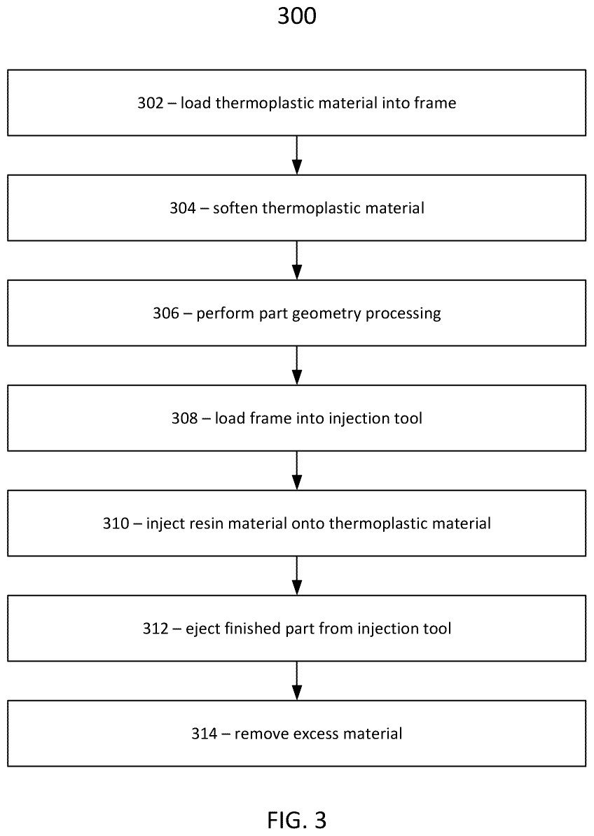

FIG. 3 shows a method 300 of manufacturing a structure (e.g., structure 100 or panel 200) according to some embodiments of the present disclosure. For example, method 300 may be used to manufacture a structure such as those shown in FIGS. 1A-2E or other structures including a thermoplastic material one side and a resin material on an opposite side chemically bonded to one another.

At 302, a sheet of thermoplastic material can be loaded into a frame. As noted above, this material may be a TPE such as TPO. The frame may be configured to be installed in an injection tool, which can perform subsequent portions of method 300. In some embodiments, the sheet of thermoplastic material may be pre-grained to have an A-side texture as described above. In some embodiments, the sheet of thermoplastic material may be formed with a thinner portion than surrounding portions, where this thinner portion defines a tear seam as described above.

At 304, the sheet of thermoplastic material may be softened. For example, the frame and thermoplastic material may be heated within an oven or using other heating tools and/or techniques. The thermoplastic material may be heated to a softening temperature for the particular material being used. For example, in some embodiments the thermoplastic material may be heated to 120-170° C. for softening depending on sheet thickness, composition, and A-side surface complexity and/or curvature (e.g., the sheet may need to be heated more to avoid tearing into deeper pockets or grooves formed thereon).

At 306, part geometry processing may be performed if necessary for the intended final structure shape. For example, if the final structure is to have a curved surface, especially a complex curved surface, the frame may be shaped to define the curved surface. The frame and thermoplastic material may be exposed to a partial vacuum environment at this stage to suck the thermoplastic material tightly to the frame and thereby improve shape retention in subsequent processing during method 300.

At 308, the frame and thermoplastic material may be loaded into an injection tool. The injection tool may be any injection molding tool or machine, novel or known to those of ordinary skill in the art, that is capable of injecting resin onto the thermoplastic material. The injection tool may include a mold configured to define a shape for the resin, which may include one or more surface features as described above, if desired. In some embodiments, the injection tool may include an in-mold graining function which may be used to form an A-side texture in the thermoplastic material as described above. The injection tool may score or otherwise thin a section of the thermoplastic material to form a tear seam in some embodiments.

At 310, the injection tool may injection mold the resin material to the thermoplastic material, thereby chemically bonding the resin material to the thermoplastic material and forming a structure comprising a first side comprising the thermoplastic material and a second side comprising the resin material. As noted above, the resin material may be a polyolefin such as polypropylene. For example, the injection tool can directly inject a polypropylene based resin onto a polypropylene based thermoplastic skin, as noted above, to create a chemical bond between polypropylene molecules in the respective materials. The chemical bond can provide a required adhesion and/or peel strength (e.g., for automotive interior use) without the addition of adhesives. In some embodiments, for example, peel strength may be greater than or equal to 500 N/m.

At 312, the injection tool can inject the finished part formed at 310. The part can be removed from the frame.

At 314, any desired post-processing of the finished part may be performed. For example, any excess material attached to the finished part, whether thermoplastic or resin, may be trimmed away.

While various embodiments have been described above, it should be understood that they have been presented by way of example and not limitation. It will be apparent to persons skilled in the relevant art(s) that various changes in form and detail may be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A structure comprising:
a first side comprising a thermoplastic material; and
a second side chemically bonded to the first side by injection molding, the second side comprising a resin material.

2. The structure of claim 1, wherein the thermoplastic material comprises at least one thermoplastic elastomer (TPE).

3. The structure of claim 2, wherein the at least one TPE comprises thermoplastic polyolefin (TPO).

4. The structure of claim 1, wherein the resin material comprises at least one polyolefin.

5. The structure of claim 4, wherein the at least one polyolefin comprises polypropylene.

6. The structure of claim 1, wherein the thermoplastic material further comprises a tear seam.

7. The structure of claim 6, wherein the tear seam comprises a molded portion of the thermoplastic material that is thinner than a surrounding portion of the thermoplastic material.

8. The structure of claim 1, wherein the first side comprises a textured outer surface.

9. The structure of claim 1, wherein the second side comprises at least one surface feature configured to interface with at least one of a vehicle structure and a vehicle component.

10. The structure of claim 9, wherein the vehicle component comprises an airbag housed by the at least one surface feature of the second side.

11. A method comprising:
injection molding a resin material to a thermoplastic material, thereby chemically bonding the resin material to the thermoplastic material and forming a structure comprising a first side comprising the thermoplastic material and a second side comprising the resin material.

12. The method of claim 11, wherein the thermoplastic material comprises at least one thermoplastic elastomer (TPE).

13. The method of claim 12, wherein the at least one TPE comprises thermoplastic polyolefin (TPO).

14. The method of claim 11, wherein the resin material comprises at least one polyolefin.

15. The method of claim 14 wherein the at least one polyolefin comprises polypropylene.

16. The method of claim 11, further comprising forming a texture on an outer surface of the thermoplastic material.

17. The method of claim 11, further comprising forming a tear seam in the thermoplastic material.

18. The method of claim 17, wherein forming the tear seam comprises molding a portion of the thermoplastic material to be thinner than a surrounding portion of the thermoplastic material.

19. The method of claim 11, further comprising trimming at least one of excess thermoplastic material and excess resin material after the molding.

20. A method comprising:
loading a sheet of thermoplastic material into a frame;
heating the thermoplastic material;
placing the frame into an injection tool;
injecting a resin material onto one side of the thermoplastic material, thereby chemically bonding the resin material to the thermoplastic material and forming a structure comprising a first side comprising the thermoplastic material and a second side comprising the resin material; and
ejecting the structure from the injection tool.
